(19) United States
(12) Patent Application Publication
(10) Pub. No.: US 2002/0155622 A1
(43) Pub. Date: Oct. 24, 2002

(54) Toxic gas monitoring system

(76) Inventors: Cody Zane Slater, Calgary (CA); John Robert Finbow, East Wellow (GB); Barry David Moore, Calgary (CA)

Correspondence Address: Michael B. McMurry, 1210 Astor Street, Chicago, IL, 60610, US

(21) Appl. No.: 10/084,116

(22) Filed: Feb. 26, 2002

(30) Foreign Application Priority Data
Feb. 27, 2001 (GB) 0104777.8

(51) Int. Cl. G01N 31/22; H04M 11/04

(52) U.S. Cl. 436/181; 422/83; 455/403; 455/404; 455/521

(57) ABSTRACT

A system for monitoring potentially hazardous atmospheres in work areas includes as part of a central console unit, a central, single or multi-gas fixed or mobile gas monitor fitted with a master radio transmitter unit adapted for communication with a plurality of mobile slave radio-pager units.

### FIELD OF THE INVENTION

This invention concerns improvements in or relating to toxic gas monitoring systems.

### BACKGROUND OF THE INVENTION

Such systems include instruments for monitoring hazardous gas conditions in industrial locations where groups of several individuals work in a team charged inter alia with carrying out inspections, routine maintenance, or repairs within areas where such conditions are likely to occur. For example, such conditions may exist in confined spaces in steelworks, oil refineries and rigs, chemical plant, tunnels, mines, sewers, and the like where out-gassing of toxic, explosive or suffocative gases can occur.

Conventionally, protection of the work team involves equipping the foreman with a portable, gas hazard-monitoring instrument. Commonly used instruments for such purposes are fitted with from one to as many as four or five sensors to give warning of different gas hazards, for example, an electrochemical oxygen sensor to indicate low oxygen levels (hypoxia), pellistor, semiconductor or infra-red detectors for explosive gases (methane and other hydrocarbons) as well as other sensors (usually electrochemical) to warn of dangerous levels of toxic gases such as inter alia carbon monoxide (CO), hydrogen sulphide (H₂S), sulphur dioxide (SO₂), oxides of nitrogen (NO, NO₂), chlorine (Cl₂), hydrogen cyanide (HCN).

Some industrial facilities are provided with fixed-point monitors, linked by means of cabling to a central control and installed primarily to provide continuous hazard monitoring for sensitive areas, but of course, they can back-up the portable instruments carried by the maintenance team. A drawback of this current practice is that it cannot provide blanket protection to individuals in a team. At times, they could be working as much as 20 meters or more away from the foreman's or the fixed-point monitors. It is possible for a hazardous condition to exist in the vicinity of a team member (or members), but not at either the foreman's or the fixed point location, and vice versa.

It is possible to equip each team member with a portable instrument but such an approach could prove to be prohibitively expensive particularly with larger team numbers. Even if this approach were to be adopted, an individual's instrument could go into alarm mode without the rest of the team being informed of the possible danger. In order to address this shortcoming, each team member could be provided with a mobile telephone to allow and maintain contact between themselves and/or a central control if needed. The alternative of maintaining contact via cables is not really a practical option for mobile work teams. Clearly providing individual team members with not only portable instruments but also mobile telephones would increase the cost significantly. Even then, communication would depend upon the capacity of the individual to operate the telephone, which would be impossible if he had been adversely affected or overwhelmed by the very situation requiring a report to fellow team members.

### SUMMARY OF THE INVENTION

It is an object of the present invention to facilitate the means of communicating or broadcasting information relating to the presence of a hazardous atmosphere simultaneously and instantaneously to a team of individuals working within a relevant environment.

Accordingly a first aspect of the invention provides a system for monitoring potentially hazardous atmospheres in work areas including as part of a central console unit, a central, single or multi-gas fixed or mobile gas monitor fitted with a master radio transmitter unit adapted for communication with a plurality of mobile slave radio-pager units.

Each radio-page unit would be suitably carried by each member of a work team; for example, the unit may be attachable to a belt.

In practice, in the event of the central monitor detecting a hazard, an alarm is automatically transmitted by the master unit to all the slave units, thereby warning all the team members of the incident and to take the necessary precautionary measures in unison, such as donning breathing apparatus, avoiding sparking et cetera.

The cost of providing the master and slave units would be considerably lower than the current alternatives, and further the system would bring with it the immediacy of broadcast information and a team reaction to any dangerous incident.

According to a second aspect of the invention there is provided a system for monitoring potentially hazardous atmospheres in work areas including as part of a central console unit, a central, single or multi-gas fixed or mobile gas monitor fitted with a master radio transmitter unit adapted for two-way communication with a plurality of slave radio-pager units.

The master unit acts as both transmitter and receiver in relation to each radio-pager unit carried by each team member and each radio-pager unit is equipped with a transceiver tuned to the central monitor. The central console unit is conveniently further adapted to monitor the number and/or identity of radio-pager units receiving the alarm broadcast and in practice as team members evacuate the danger area and turn off their units, and thus the central unit can deduce when and/or which team members have left the relevant area. Such a facility affords a ready check on the movements and whereabouts of team members thus providing important information in the event of a hazardous event occurring. In a variation of the second aspect of the invention the gas monitoring system of the invention which is used to detect hazardous situations, each slave radio-pager unit may itself be provided with a gas monitor. Such individual gas monitors may obviate the need for a central gas monitor but it is within the scope of the invention to employ both a central gas monitor and individual gas monitors. Whilst the use of individual gas monitors on the slave radio-pager units would inevitably increase costs it would provide more localised knowledge of hazards if such were a requirement, thus affording the capability for the central unit to broadcast relevant information to other locations.

According to a third aspect of the present invention, in the system of the second aspect there is provided a plurality of portable gas monitor units for use in practice by work team members, each monitor having a transceiver capability between themselves and with the central console unit.

The central console unit is conveniently adapted to communicate additionally with some other service, for example a rescue or safety crew.

A large industrial facility could have a multiplicity of maintenance or repair cells each having a central console unit covering specific areas of a particular site. In the event that an individual's unit goes into alarm mode, a signal will automatically be transmitted to the relevant console unit and to a site master control unit, the rescue services and to other individuals of the team or other operatives working in the vicinity of the hazard. The rescue team would then take appropriate equipment, for example breathing apparatus, medical supplies as necessary to the affected individual. Other trained personnel would then enter the area to verify the cause and the source of the alarm, or indeed to establish the validity of the alarm, and then to take any remedial action as required. Situations of this kind arise particularly in underground environments, e.g. in mines, where individual team members can be out of sight or sound of colleagues. Additionally in large industrial complexes, the consequences of an alarm being raised may be that only the immediately affected area needs to be isolated and shut down, or more widespread suspensory action needs to be taken in other areas or repair/maintenance cells.

In a fourth aspect of the invention, each slave unit in the second and third aspects of the invention including transceivers may incorporate a panic button. Accordingly, in the event that a team member sustains any injury or experiences other difficulties, help may be summoned specifically to that location by operation of the panic button which identifies the team member on an individual basis.

It is to be understood that in all the aspects of the invention, additional sensors may be fitted to measure other parametric conditions, such for example as temperature or pressure thereby to trigger alarms other than those associated with chemical hazards and to transmit the alarms both to other team members and to the central console units.

We claim

1. A system for monitoring potentially hazardous atmospheres in work areas including as part of a central console unit, a central single gas fixed gas monitor fitted with a master radio transmitter unit adapted for communication with a plurality of mobile slave radio-page units.

2. A system according to claim 1 in which each radio-page unit is portable.

3. A system according to claim 2 in which the radio-pager unit is wearable.

4. A system according to claim 1 in which in use upon detection of a hazard by the central monitoring unit an alarm is automatically transmitted by the master unit to all the slave units.
